(19) United States
(12) Patent Application Publication
(10) Pub. No.: US 2022/0398659 A1
(43) Pub. Date: Dec. 15, 2022

(54) CRYPTOGRAPHIC SYSTEM AND METHOD FOR EVALUATING FINANCIAL INFORMATION

(71) Applicant: Ilya Eric KOLCHINSKY, Westfield, NJ (US)

(72) Inventor: Ilya Eric KOLCHINSKY, Westfield, NJ (US)

(21) Appl. No.: 17/763,063

(22) PCT Filed: Sep. 25, 2020
(86) PCT No.: PCT/US20/52835

§ 371 Date: Mar. 23, 2022

Related U.S. Application Data
(60) Provisional application No. 62/907,225, filed on Sep. 27, 2019.

(51) Int. Cl. G06Q 40/02; G06F 21/60

(52) U.S. Cl. CPC G06Q 40/025; G06F 21/602

(57) ABSTRACT

Third parties interested in purchasing a pool of loans run calculations to determine if the investment is worthwhile. Traditionally, obtaining the information to perform the calculations includes obtaining consumer credit information that carries liabilities under the Fair Credit Reporting Act. A method is described for performing encrypted calculations by a third party on a pool of consumer credit data stored by a regulated consumer credit provider. The method enables the third party to run the required calculations without having the consumer credit data disclosed to evoke liabilities under the Fair Credit Reporting Act. The encrypted calculations may employ arithmetic circuits, Boolean circuits and/or hybrid circuits.

### CROSS REFERENCE TO RELATED APPLICATIONS

This application claims the benefit of priority to U.S. provisional patent application No. 62/907,225, filed on Sep. 27, 2019; the entirety of which is hereby incorporated by reference herein.

### BACKGROUND OF THE INVENTION

### Technical Field

The present disclosure relates generally relates to the analysis of pooled consumer obligations using cryptographic techniques. The cryptographic approach allows an analysis of the basic underlying data without violating relevant privacy laws.

### Background

Traditionally, mortgages and other consumer debt were underwritten using the “3 Cs”: Collateral, Capacity and Credit. Collateral refers to the value of the asset that a lender can seize for repayment if the borrower defaults. Capacity is the ability of the borrower to repay the loan amount—generally it is the comparison of the borrower's income to payment commitments. Lastly, but most importantly, credit is the borrower's history for paying past debts. A traditional underwriter would analyze all three aspects in order to determine the risk that the borrower defaults.

Collateral can be seized if a borrower defaults on his obligation. The difference between the value of the Collateral at default and the loan amount can be used to estimate the Loss-Given-Default (“LGD”, also known as “severity”) as well as the borrower's potential propensity to default. For example, to determine the value of the collateral, a traditional underwriter of residential mortgages would obtain independent appraisals of a home's value.

Capacity analyzes the borrower's ability to pay back the loan. A traditional underwriter compared the income of a borrower to the payments he needs to make on a periodic basis to remain current on his loans. Common ratios are the debt-to-income ratio (“DTI”) and debt service coverage ratio (“DSCR”:total periodic income over total periodic payments). To calculate these ratios, the traditional underwriter diligently documented the borrower's income and all required debt payments.

However, collateral and capacity cannot answer critical questions about borrower's behavior. For example, what happens if a borrower's income is reduced, because he loses his job? This is where the most critical aspect of the analysis—credit—comes in. Credit is a measurement of a borrower's propensity to repay debts as reflected in his track record of past behavior. For example, some borrowers continue to pay their debts even if the value of their collateral is less than the amount borrowed. Traditionally, the underwriter would attach great importance to a borrower's credit history to make a lending decision.

In the US, consumer Credit history is collected by the Credit Reporting Agencies (“CRAs”). There are three major CRAs: Experian, EquiFax and TransUnion. Each CRA collects information about consumers based on reports from lenders. The Consumer Credit Information (“CCI”) contains each individual's name, current and past addresses, open credit accounts, loan balances and payment history. Due to a number of privacy, crime prevention and anti-discrimination concerns this information is highly regulated.

In the US, this is done under the auspices of the Fair Credit Reporting Act (“FCRA”). The FCRA regulates not only the CRAs but also the users of credit reports. A credit report is “any information . . . bearing on a consumer's credit worthiness, credit standing, credit capacity, character, general reputation, personal characteristics, or mode of living”. The FCRA mandates compliance, document disposal and sunset provisions for adverse information. Private litigants may bring lawsuits and collect punitive damages for non-compliance. Crucially, in order to fall under regulatory scrutiny consumer reports must relate to an identifiable individual.

Structured Finance is a group of financial products which consolidate investment assets into segregated pools. These pools then issue various levels of debt, called “tranches”, to investors. Tranches differ on their priority in receiving principal, interest and/or allocation of losses. The underlying assets for securitization vary and can include loans secured by commercial properties such as office buildings or loans to industrial companies.

Analysis of structured finance investments typically proceeds through four conceptual steps: macro-economic assumptions model; credit model; waterfall; and valuation. Macro-economic assumption model step 12 attempts to determine what future economic conditions will look like. This step calculates variables which are exogenous to the structured finance investment but influences the performance of the underlying loans. These assumptions must match the exogenous variable used to parametrize the credit model in the following step. For example, for residential mortgages, the assumptions may predict the Case-Shiller Home Price Index. There may be only one assumption or several based on a range of economic states (e.g. base, optimistic and stress).

The second step, credit model 14, combines the exogenous (macro-economic) assumptions with some information about the loans themselves to predict the performance of each loan. For the purposes of investment analysis, three measures of performance are crucial: principal paid, interest paid and loss. Models vary in their complexity. Some are Monte-Carlo simulations while others are deterministic. Older models calculate the overall performance of the loan pool as a whole based on average characteristics. Newer models predict performance of loans on a loan by loan basis calculating principal, interest and losses per loan on a monthly basis. The output of credit model 14 is a generally time vector of relevant pool performance measures. For example, the percentage of loans defaulting, the percentage of loans being pre-paid and the interest paid in month one for the entire pool and so on.

Waterfall step 16 is the set of legal rules applied to the particular transaction which allocate the outputs of the previous step to various investors in the transaction. This is the “structured” part of the instrument. Some investors forgo higher interest rates to be paid first, while other receive a premium to be paid last. Typically, a transaction has a senior investor who receives interest and principal first. When losses occur in the pool, the senior investor is last to be impacted. On the other hand, the “first loss” investor (as the name implies) is the first to suffer losses (usually by a reduction in its principal) and the last to receive principal and interest. Waterfalls differ deal by deal and are transparent to investors. Aggregate pool-level cash flows are allocated via steps to different investors. The output of waterfall 16 is a time vector of principal paid, interest paid and losses for each investor (by tranche) in a transaction.

Lastly, valuation step 18 is mostly a conceptual step which reduces the time vectors determined above to one or two variables. The most common are price and/or credit rating.

Traditional underwriting of consumer credit (e.g. to qualify for a mortgage) involved analysis of specific personal and private data about the borrower. The loan underwriter or analyst had to have actual knowledge of the data in order to analyze it. Due to privacy and other concerns, this data is rightfully protected by federal law from broad distribution.

The advent of dis-intermediated financial products such as structured finance limited the ability of analysts and investors to use the original data in their analysis. This resulted in reliance on proxies such as the credit score (FICO or Vantage) for analysis. The inadequacy of these proxies was in evidence in the performance of US mortgage-backed securities during the Global Financial Crisis (“GFC”).

As discussed above, underwriters traditionally used the 3 Cs, collateral, capacity and credit, to determine a borrower's propensity to default and the prospective LGD. However, due to regulatory prohibitions, an analyst of structured finance products (“analyst”) has never had access to the same information available to traditional underwriters of consumer loans. Regulations severely restrict the amount of credit information available to analysts, and capacity is effectively restricted to verification of income. As result, structured finance investors primarily focus on collateral in their analysis in the prior art. As the GFC plainly showed, this reliance was misplaced—collateral values were overstated and were not sufficient to repay the balance of the mortgage loan.

Despite the heavy reliance on the collateral, the information provided to the structured finance investor is also limited for privacy reasons. For example, Reg AB [17 CFR § 229.1125] does not require that the address of the property be disclosed—instead only the first two digits of the zip code is provided.

As a result of restrictions on the distribution and use of CCI, analysts typically use “blind proxies.” Blind proxies are summaries of the underlying CCI. The most commonly used blind proxies are credit scores—either the FICO or the Vantage Score. The credit score is an algorithm which uses the underlying CCI to derive a single quantitative measure of Credit. For example, the FICO score ranges from 300 to 850. While there are no official categories, scores below 600 generally constitute subprime borrowers, while scores above 800 are considered exceptional. The algorithm to determine the credit score is proprietary, but the general factors affecting it are well known. As a result, credit repair services offer a number of products to increase a credit score.

While blind proxies may have some uses in certain credit decision situations, the reliance on credit scores in analysis was one of the main factors leading to the GFC. There are a number of reasons why this occurred: blind proxies can be gamed; investors may not receive the actual information; and proxies are static and do not vary with other analyst assumptions.

Because proxies are blind, consumers and loan originators have found a way to game these numbers. Credit repair shops advise consumers on how to manage their credit files to increase their credit scores by, for example, applying for extra credit cards. Unfortunately, this behavior does not change the consumer's propensity to default. Meaning that credit scores typically overestimate the likelihood that borrowers will avoid default. Furthermore, since each of the three major CRAs provide a slightly different credit score, loan originators typically report only the highest to the ultimate investor—losing even more information.

As a number of post-GFC lawsuits made clear, the credit scores which were reported to analysts and investors did not reflect the actual values assigned to the borrowers. In some cases, the credit scores were simply made up. This was mainly due to fraudulent practices on the part of mortgage originators, bankers and others. Nevertheless, it demonstrates the hazards of working with derived information in the context of disintermediated financial products. There was simply no means for investors to check the veracity of the data they received.

It is common for analysts to run a number of scenarios reflecting different economic outcomes. At a very minimum, “base” and “stress” scenarios are used. Each scenario assumes a number of macro-economic conditions which are relevant to the model. In the case of consumer backed structured finance, these conditions may include unemployment, gross domestic product and home price appreciation (for mortgages). The base scenario includes the expected conditions while the stress may imply a recession.

Unfortunately, credit scores are static—their predictive value (if any) exists only for one single scenario, not a range. Obliviously, a consumer is a different credit risk in benign economics than he is in recession. Worse, since the credit score algorithm is unknown to an Analyst, it is unclear what scenario the score is optimized for. If it for a mild stress, then its use for the base would be conservative, but its use in a stress scenario would be aggressive. Another way to think about this is that the available credit score is the mean of whatever distribution that is used to derive it. Any averaging loses a great deal of information about the distribution—the variance, bi-modality, etc.

Structured finance investments were broadly blamed for the GFC. At the core of the crisis were residential mortgages which were packaged into RMBS (Residential Mortgage Backed Securities). RMBS are structured finance instruments which hold pools of residential mortgages and allocate cash flows according to a set of rules (waterfall) to investors. Because some of the junior tranches were hard to sell, investment banks used another instrument, the Collateralized Debt Obligation (CDO), to buy these securities. CDOs were themselves structured finance instruments whose underlying pool consisted of other securities. While these securities could in theory be anything, they primarily consisted of RMBS and other CDOs.

In structured finance, credit scores were used as blind proxies to determine the probability of default of borrowers in pools backed by consumer assets. In the case of residential mortgages, credit scores along with LTV were the most crucial variables in the credit model stage of analysis. The use of blind proxies contributed to the mis-valuation of structured finance products which caused the GFC. Since CCI was not available to analysts and investors in RMBS, they were forced to use only aggregated information for their analysis. This reliance on blind proxies resulted in a variety of issues discussed below.

First, all parties involved in mortgage transactions, from mortgage brokers to loan originators to loan aggregators to security underwriters, have a clear financial incentive to make borrowers look more creditworthy than they actually are in order to sell their loans or pools of loans to the next participants in the RMBS chain. In the years leading up to the GFC, unethical participants in these transactions took advantage of the fact that analysts and RMBS investors lacked access to CCI by providing inaccurate borrower information to them. A number of post-GFC lawsuits made clear that, at times, the credit scores reported to analysts and investors did not reflect the actual values assigned to the borrowers. In some cases, the credit scores were simply made up.

Second, traditionally, mortgage loans taken out by borrowers on their primary residences are less likely to default than mortgage loans taken out on vacation homes or properties owned for investment purposes. Most analytical models reflect this reality. Since mortgage loans for owner-occupied properties typically charge lower interest rates than mortgage loans for other residential properties, borrowers for investment properties and second homes are incentivized to lie about the purposes of a residential home underlying a mortgage loan. In the years leading up to the GFC, many borrowers misrepresented the purposes of their mortgaged residential properties, causing various measures of expected default probability to greatly underestimate defaults.

Third, severe analytical gap occurred because of borrowers refinancing from non-payment. Many borrowers took on mortgages which they could not afford. This could be for their primary homes or for investment properties. In some cases, these borrowers only made one or two payments. To avoid foreclosure, these borrowers simply refinanced their mortgages. Refinance was possible because home prices (i.e. Collateral) were rising while the borrower's credit score was only slightly damaged. While this information is critically vital to an investor—after all, previous non-payment is the best predictor of future payment—investors had no access to this information. In structured finance, this delinquent borrower appeared in a new transaction as a fresh loan with no evidence of prior behavior other than a slightly lowered credit score.

These issues demonstrate clearly the hazards of working with derived information in the context of disintermediated financial products. There was simply no means for analysts and investors to check the veracity of the data they received, incentivizing market participants to lie. On top of outright fraud, the use of blind proxies raised other issues as discussed below.

### SUMMARY OF THE INVENTION

Third parties interested in purchasing a pool of loans run calculations to determine if the investment is worthwhile. Traditionally, obtaining the information to perform the calculations includes obtaining consumer credit information that carries liabilities under the Fair Credit Reporting Act. A method is described for performing encrypted calculations by a third party on a pool of consumer credit data stored by a regulated consumer credit provider. The method enables the third party to run the required calculations without having the consumer credit data disclosed to evoke liabilities under the Fair Credit Reporting Act. The encrypted calculations may employ arithmetic circuits, Boolean circuits and/or hybrid circuits.

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

Modern cryptographic techniques allow parties to analyze data without actual knowledge of the data or reliance on trusted third parties. These techniques are commonly known as Secure Multi-Party Computation (“MPC”). Embodiments apply MPC techniques to consumer data for analysis in disintermediated financial products. They do this without analysts having any knowledge of the data, thus shielding them from legal or regulatory liability. The invention restores the traditional balance of information in underwriting and protects the stability of the financial system and may prevent a future market collapse similar to the GFC while maintaining mortgage access for consumers.

Regulation of CCI has been separating the data from the analyst. The use of blind proxies in the analysis of structured finance was the cause of the GFC. The present invention solves the problem by applying the analysis cryptographically thereby allowing the analyst to control the analytical process directly without using proxies or having actual or legal knowledge of CCI.

Personal data, as used herein, may include a person's or borrower's name, social security number or other government identifier number, and the like. Analyte data is data that is required for analysis by a third party, such as financial institutions including banks and credit unions, and includes loan amounts, loan data, liability amounts, income, credit score and other consumer credit data except the personal data. As used herein, regulated consumer credit providers, includes financial institutions, credit reporting agencies and other organizations that collect and store consumer credit information. In an exemplary embodiment, regulated consumer credit providers are defined in the Fair Credit Reporting Act (FCRA) 15 U.S.C. § 1681, September 2018 revision; incorporated by reference herein.

### BRIEF DESCRIPTION OF SEVERAL VIEWS OF THE DRAWINGS

FIG. 1 shows a diagram of models used for evaluation of a loan or pool of loans by a third party.

FIG. 2 shows a diagram of the information flow with respect to a consumer obtaining a loan.

FIG. 3 shows a diagram of a proposed information flow in the analysis of a security backed by the consumer loan in FIG. 2.

FIG. 4 shows a diagram of the flow chart for an embodiment of the invention.

FIG. 5 shows a diagram of the initial information known by the various parties for an embodiment of the invention.

FIG. 6 shows a diagram of preprocessing round of the analysis of data for an embodiment of the invention.

FIG. 7 shows a diagram of round 1 of the analysis of data for an embodiment of the invention.

FIG. 8A shows a diagram of first part of round 2 of the analysis of data for an embodiment of the invention.

FIG. 8B shows a diagram of second part of round 2 of the analysis of data for an embodiment of the invention.

FIG. 9 shows a diagram of the aggregation round of the analysis of data for an embodiment of the invention.

FIG. 10 shows a diagram of a parallel processing platform.

### DETAILED DESCRIPTION OF THE ILLUSTRATED EMBODIMENTS

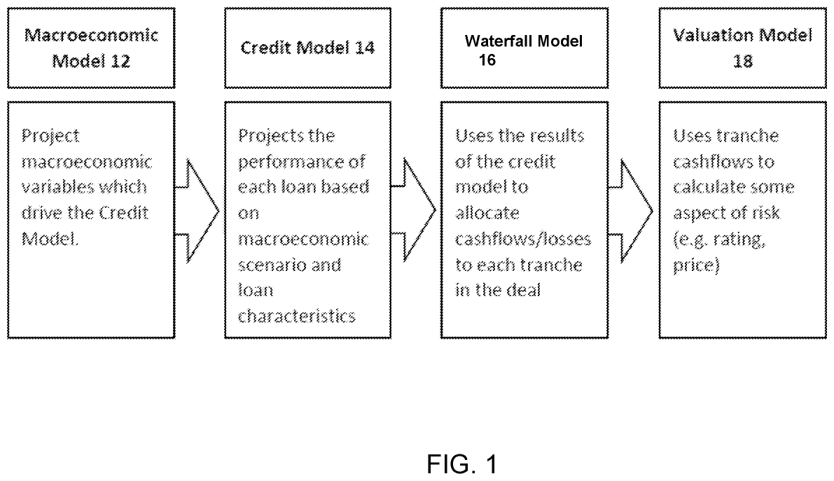

Embodiments primarily deal with the Credit Model step (step 14 in FIG. 1). The Credit Model seeks to project the performance of a loan—focusing primarily on the probability of default (“PD”) and LGD. Default has varied definitions, but usually involves non-payment which is uncured for a period of time (say 180 days). Default can cause a responsible party (typically a servicer) to seize the collateral and sell it to satisfy the loan amount. The difference between the loan amount and the proceeds received from selling collateral is known as the severity or LGD.

Embodiments covers a process by which a number of parties cryptographically analyze legally protected consumer information, such that the analyzing party does not learn (legally or actually) such information.

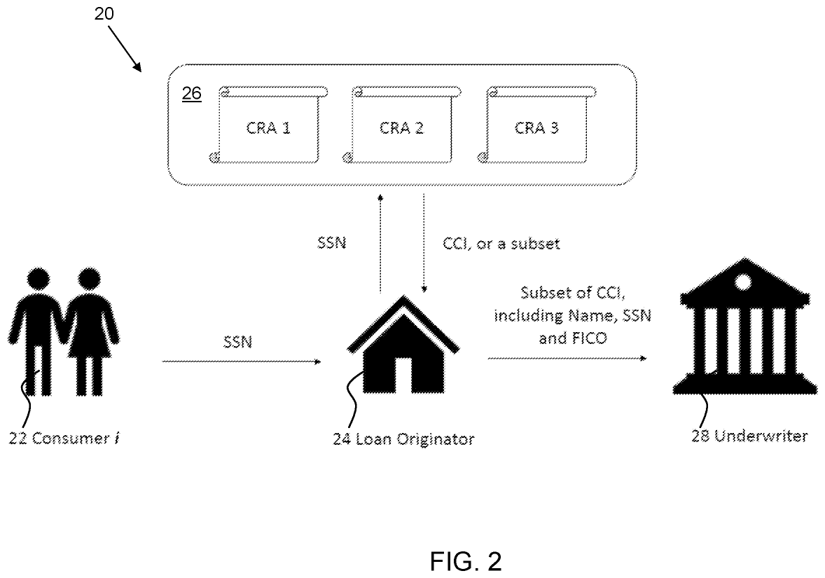

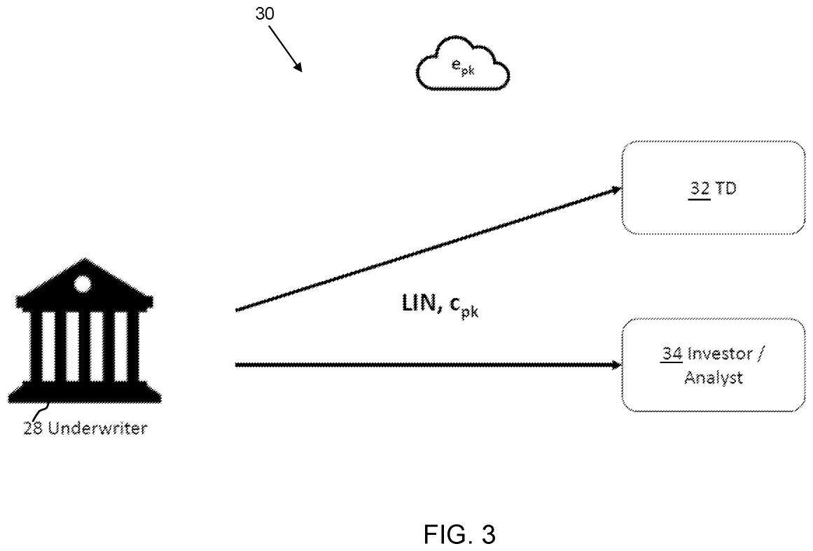

Embodiments may involve as few as 2 parties—the holder of the CCI and the party requiring the analysis. In some embodiments, there are three primary parties to consider, as described below in FIGS. 2 and 3. One or more CRAs holds CCI which is a combination of public CCI (cₚₖ) and secret CCI (cₛₖ) as defined below. The analyst seeks to determine the output of the analytic, holds secret scenario information (sₛₖ) and also knows cₚₖ. Trusted dealer (TD) assists the analyst in preparing the analytic, and it should also be assumed that the knows cₚₖ. In some embodiments of the inventions, the TD would also have a role in providing randomness or acting as a party in the analytic. Note that some embodiments can work without a trusted dealer.

CCI is the consumer credit information. Some portion of that information, cₚₖ, is assumed to be known by the Analyst and TD based on information available in the transaction analyzed. For example, the principal balance of a mortgage loan is part of CCI. If that loan is securitized than the principal balance information is available to the analyst as cₚₖ. Given the public nature of US mortgage recording, it is very easy to link a specific individual with a mortgage even if the name is not given in cₚₖ. This is done by linking the mortgage balance (which tends to be rather unique) with other pieces of available cₚₖ such as closing date and interest rate. Key to maintaining privacy and avoiding regulatory liability is ensuring that the analyst is unable to infer cₛₖ, given the output and cₚₖ. Note that cₛₖ is contains both the identity of a consumer and his credit information.

The scenario information sₛₖ is created by the analyst and acts to fine tune each analytic. It may include varied interest rate scenarios and economic stresses. The types of scenarios are closely linked to the analytic used. Preferably, only the analyst knows sₛₖ. The secrecy of sₛₖ acts as a proof of accuracy for the analyst and as a check on CRA and TD. For example, the analyst can select two scenarios sₛₖ¹ and sₛₖ² which are negligibly different from one another (e.g. interest rates increase by 1% vs interest rates increase by 1.001%). The outputs of these two scenarios should also show negligible differences. However, if sₛₖ is kept secret, the analyst could judge the correctness of the output since TD and CRA do not know how different sₛₖ¹ and sₛₖ² are in reality. The scenarios could also reflect extreme scenarios. In any case, CRA and TD will need to perform their roles accurately.

Lastly, we define extraneous information, eₚₖ, as the exogenous information which can be used to match cₚₖⁱ to identify the consumer i. eₚₖ is information available to any party outside of the specific transaction which is being analyzed. Unlike cₚₖⁱ, eₚₖ includes the name of the consumer. For example, for mortgages, eₚₖ includes country mortgage recording data. Mortgages are typically publicly recorded at the county level and a third party can easily find the name of the borrower using the principal balance, location information, interest rate and closing date.

One purpose of the invention is to allow the parties to directly perform analytics on the data without changing the parties' legal status with respect to the data. Broadly, it is assumed that both TD and the analyst can identify the consumer using the already available cₚₖ and eₚₖ. As the result of the operation of the invention, the analyst and, potentially, TD will receive the output. To meet the set legal objectives, both TD and the analyst must not be able to obtain actual knowledge of cₛₖ. Furthermore, neither analyst nor TD should be considered to have received a “credit report” as defined by the FCRA. In addition to the above objective, this implies that no information can be inferred about an individual consumer other than what could have been inferred from cₚₖ.

Furthermore, neither the analyst nor TD should be able to learn cₛₖ the data which they would not have otherwise. Furthermore, neither the analyst nor TD should be able to discern the anything about cₛₖⁱ (for a consumer i) given the output of an analysis (oₘ) other than what was could be inferred in cₚₖⁱ. The following table summarizes the information goals. Given the above framework, we define the Pool-Level Privacy (PLP) aspect as the probability that a non-CRA party determines that a given oₘ belongs to consumer i is negligible.

TABLE 1

| Role | Knows | Cannot Learn | Pool-Level Privacy |
|---|---|---|---|
| CRAs | cₛₖ, eₚₖ | n/a | n/a |
| TD | cₚₖ, eₚₖ | cₛₖ | Any aspect of cₛₖ |
| | | | given [o, cₚₖ, e_{pk]} |
| Analyst | cₚₖ, sₛₖ, eₚₖ | cₛₖ | Any aspect of cₛₖ |
| | | | given [o, cₚₖ, e_{pk]} |

FIGS. 2 and 3 illustrate the information flow within cooperating systems 20 and 30 to meet the rules of Table 1 during mortgage securitization. Consumer (i) 22 applies to a loan originator 24, and provides personal information, such as social security number. Loan originator 24 sends the personal information to Credit Rating Agencies 26 to pull a credit report for consumer 22. Loan originator 24 is provided with CCI, or a subset thereof. Because CCI includes personal identifiable information for the consumer, CCI must be carefully managed. Loan originator 24 works with underwriter 28 to obtain the mortgage. To do this, sensitive information is sent to underwriter 28. This includes a subset of CCI, including name, Social Security number and FICO score for consumer 22.

Underwriter 28 then works with TD 32 and investor/analyst 34 to securitize a mortgage or a bundle of mortgages. Each entity in FIG. 3 is a legal entity and a computer system connected to one another, preferably by a secure connection over the Internet. Each entity is therefore capable of related communications and computational tasks to accomplish the steps described herein. For example, the underwriter can bundle the mortgages for multiple consumers into a security which is marketed to investor/analyst 34. However, because investors/analyst 34 needs to properly evaluate the security without accessing personal information for the parties to the various mortgages in the bundle, investor/analyst 34 works with TD 32. To accomplish this, both analyst and TD receive a subset of data (cₚₖ) that does not include the name of the borrower or their Social Security number. However, the information does include a unique loan identification number. In addition, all parties have access to eₚₖ, which is publicly available extraneous information. The specific cryptographic methods that TD 32 and investor/analyst 34 used to evaluate the security are discussed below.

Cryptographic techniques are centered around the algorithmic allotment of information, which parties can receive information, the correctness of information, the power of the parties trying to steal information, etc. Modern research in this area has formalized these constraints and has created a large number of techniques for a number of permutations of these requirements. The minimum information requirements required to perform the invention are Correctness, Privacy and Pool-level Privacy.

Correctness is the requirement that the output is correct after the application of the cryptographic technique. If D {cₛₖ, cₚₖ, sₛₖ}=o is the unencrypted analytic and TECH(D, cₛₖ, cₚₖ, sₛₖ) is the cryptographic technique to perform the analytic, then Correctness is defined as

Pr[TECH(D, cₛₖ, cₚₖ, sₛₖ)=o]=1

A formal definition of Privacy is not pertinent to the description of this invention. We can informally define Privacy as the probability that an adversary learns private inputs as being negligible or less. For the purposes of this invention, Privacy means that the probability of the analyst or TD learning cₚₖ is negligible. Likewise, the probability of the CRA or TD learning sₛₖ (if the Analyst chooses to keep this secret) is likewise negligible.

Most currently available cryptographic techniques are not general enough to cover exogenous information, however, so in order to ensure the legal objectives, we must define an additional requirement which this invention provides. Pool-level Privacy (PLP) is a requirement introduced in this invention. The information requirement of PLP was described above. Mathematically, PLP is defined as follows. Assume there exists an algorithm which can link the output of D {cₛₖk, cₚₖ, sₛₖ}=o to the identity of the consumer:

LINK (D, o, Cₚₖ, eₚₖ)=i

Where i is the identity of the consumer. Then PLP requires that

$$Pr [ LINK ( D , o , {c}_{p k} , {e}_{p k} ) = i d ] \underline{<} \frac{1}{n}$$

Where n is the number of consumers in a pool, for a reasonably large n. This means that the probability of determining the identity of the consumer's output in a pool is less than or equal to randomly selecting a consumer in a pool. There are number of other cryptographic requirements which are defined for cryptographic techniques—number of adversaries, adversary type (malicious, honest-but-curious, passive, active), the computational bound of the adversary (computationally bound, unbound), security of the communication channels, etc. embodiments are not limited to these requirements—any of which can be applied depending on the legal framework.

Various embodiments can be implemented in three phases: the analytic build phase, the offline phase and the online phase.

The first step is to build the analytic function which connects the public and secret inputs to the desired outputs. The analytic may be designed to calculate defaults, recoveries or losses as desired. We define an analytic D as some function of {Cₛₖ, cₚₖ, sₛₖ} and generates an output o. During the analytic build phase TD and the analyst work together to create an appropriate analytical procedure which matches the analyst's needs. Once complete, TD complies the analytic into an appropriate cryptographic circuit.

During the analytic build phase, the agreed upon analytic is transformed into a framework where it can be used cryptographically. The preferred embodiment of the invention is agnostic with respect to the type of encryption framework used. Currently, there are number of frameworks in the literature, optimized of various types of analysis. Broadly, there are two main approaches, garbled circuit (optimal for Boolean functions or circuits), secret sharing (optimal for arithmetic functions or circuits) and hybrids of the two or hybrid circuits. Since there is a map between Boolean and arithmetic functions and most real-world functions are a mix of the two, many encryption frameworks are able to handle a broad range of analytics. Nevertheless, not all of these frameworks are efficient for every calculation.

Other analytic parameters also drive complexity. A choice needs to be made between a recurrent approach where the analytic is queried once per relevant period (typically a month in consumer finance) and where is accessed once for the entire life of the loan. The former has the potential of being more precise, while requiring fitting of many more variables with the requisite increase in processing time and overfit potential. Next, the analytic must assure PLP. As shown below, this can be done by delivering the combined pool level result as demonstrated in the example analytic.

An offline phase is deal and analysis specific. For example, certain cryptographic frameworks require the generation of a list of random numbers to be used during the process. The offline phase also includes the mapping and random permutation of the loans for each scenario to be run.

During the online phase, the CRAs, TD and analysts cryptographically exchange the data required for analytic D and compute o. This phase is specific to each scenario that the analyst wishes to run.

To demonstrate the implementation of some embodiments of the inventions we define an analytic for calculating defaults in a pool of loans:

Dₗ=ΣΣcₛₖ^{i,j}pₛₖⁱw^{j}s^{j}

Where Dₗ is the default amount of pool l made of loans to consumer i. cₛₖ^{j,i} is the j^{th} element of the secret credit information provided by the CRA about consumer i. For example, cₛₖ^{j,i} could represent the amount of credit card debt currently delinquent, while cₛₖ^{j+1,i} could be credit card debt over 30 days delinquent and so on. pₚₖⁱ is the principal balance of loan i. pₚₖⁱ is a subset of cₚₖ. w^{j} represents the coefficient for each secret input cₛₖ^{j}. It is expected that many of the w^{j} will be set to zero. s^{j} is the analyst's secret scenario inputs. These inputs alter the effect of a given cₛₖ^{j} under a given macro-economic scenario.

The linearity of the analytic allows for a number of simplifications in structuring the algorithm. To implement this analytic some embodiments use an MPC framework based on Linear Secret Sharing (LSS). LSS protocols are based on the idea that an m-order polynomial can be fully defined by m+1 point. However, knowledge of only m points yields an infinite number of solutions. For example, a line is a first order polynomial and can be fully described by two points. On the other hand, a person with only one point on the line is faced with an infinite number lines which pass through that point.

The idea behind LSS is to embed a secret in an arbitrary polynomial—typically in the zero order term. For example, say we wish to secretly share the number 7 among two parties. We define an arbitrary polynomial y=4x+7 and generate two arbitrary points on the line (1,11) and (3,19). We send the first to Party A and the second to Party B. Neither party can determine the secret only with the point they have—it can only be reconstructed with the two points. With the line reconstructed, the two parties can then extract the secret which is the y-intercept term.

LSS-based MPC involves a number of parties sharing private information with one another in the same fashion. The receiving parties can perform calculations on the various shares and then combine them to get the final result. Addition can be done locally, while a number of “tricks” need to be used to perform multiplication. In this example, multiplication will be done locally using Beaver Triples (BT). While the use of BT assists in the efficiency of the calculation, the example can be implanted using other algorithms to effectuate an analytic.

For simplicity, we will designate shares of x=(x₁, x₂, . . . , xₙ) as <x>. The algorithm is as follows:

TABLE 2
Algorithm: Run Analytic

1. [Offline] Loans in the pool are mapped and permuted.
2. [Offline] TD calculates and distributes a list of BTs: a, b and c = ab.
3. [Online] For each loan l, c and s perform:

| | a. Analyst sends loan id as well as shares in <s*w> and BTs to |
|---|---|
| | CRA(s). |
| | b. CRAs sends shares in <p*c> and BTs to Analyst |
| | c. All parties perform their respective share multiplication |
| | d. Analyst sets <D>_{Analyst} = <D>_{Analyst} + <s*w*p*c> and stores its |
| | results locally |
| | e. CRAs calculates <D>_{CRA} = <D>_{CRA} + <s*w*p*c> and stores its |
| | results locally. |
| 4. | Once all the loans, scenarios and cₛₖ have been, CRA sends its |

aggregated result shares to Analyst. The Analyst combines both shares
to learn the output.

This approach fulfills the desired information objectives. LSS frameworks definitionally provide privacy and correctness. The analyst cannot learn cₛₖ because the party only receives shares of the information. This approach also fulfills the Pool-level Privacy objective, since the analyst is only able to open shares once all the consumers' information has been processed. It is impossible to learn the results of a single borrower since the analyst never sees any unencrypted individual loan results.

A similar analysis can be applied to TD. This party learns even less since it is not a part of the loan-by-loan exchange and only receives the shares of the performance of the entire pool. Furthermore, TD does not learn the final result of the process since the opening of the shares was done by the analyst. While embodiments need not place explicit requirements on the knowledge of the CRAs, CRAs are not able to learn anything new from the interaction with the analyst or TD.

While this example covers a specific use of cryptography, embodiments can cover any bundling of consumer credit information where CCI needs to be analyzed while maintaining privacy of the consumer. The process of creating and selling of a consumer structured finance security (the “security”) goes through several stages. Discussing this example in the framework of FIGS. 2 and 3, first, the loan or another obligation is made to consumer 22. The party which makes the loan (the “originator” 24) is typically not involved in the final construction or marketing of the security. Nevertheless, originator 24 is tasked with collecting relevant information about consumer 22, some portion of which will become cₚₖ.

The loan, as well as the information about the consumer 22, is passed along by originator 24 through other parties until they rest with the underwriter of the security. The role of underwriter 28 is to create the security and to market it to various investors. In this example, analyst 34 is assumed to be an agent of an investor whose goal is to understand the risk of the security and to make a decision on purchasing or pricing. The marketing process varies by type of security as does the amount of the time the analyst is afforded to make their decision. The amount of information given to analyst 34 varies as well. In the US, the underwriter is not only bound by the FCRA, but also by the consumer protection provisions of the Gramm-Leach-Bliley Act. As a result the Underwriter is incentivized to keep the scope of cₚₖ to a minimum.

While the example used here is strictly linear and arithmetic, the approach described here can be extended to other arithmetic, Boolean and hybrid (arithmetic/Boolean) analytics or circuits. This step assumes that analyst 34 has developed or chosen an analytic or a set of analytics for a particular transaction. For example, Dₗ^{t} is the set of analytics capturing the defaulting principal of a particular transaction for time periods t from 1 to 360 months (assuming that the transaction has a 30 year maturity).

Within each analytic Dₗ, in some embodiments, each w^{j} and s^{j} also vary with t. (The calibration of these variables is done with cryptographic model fitting techniques.) In this example of the preferred embodiment of the invention, neither the CRAs 26 nor TD 32 know the w^{j} and s^{j}. Each cₛₖ to be queried by the invention is assigned a unique label from the relevant CRA's data dictionary: c_{label}.

Prior to the analysis, CRA 26, TD 32 and analyst 34 install software implementing the invention in their respective databases.

In the case of a specific security, underwriter 28 assigns an arbitrary unique loan identification number (LIN) to each borrower. Underwriter 28 sends a list of LINs along with identifying information (such as the social security number) to CRAs 26. At the time of the marketing of the transaction, underwriter 28 also sends only the list of LINs to analyst 34.

A highly simplified example assumes that D uses two cₛₖ, the pool consists of two loans, only one time period and scenario. Additionally, we assume only one CRA. In a more realistic example, analyst 34 will likely run at least three scenarios—a base (which assumes that the economic performance will match historical levels); stress (the economy will enter into a recession) and a check scenario. The check scenario is imperceptibly different from one of the other scenarios (and is used to ensure that the CRA and TD are honest). Assuming that the pool of loans backing a security contains 1000 loans, the analytic D uses 5 cₚₖ variables, 360 monthly periods and three scenarios, the implementation will require 5.4 million queries. The analyst then permutes each query for added security.

$${D}_{example , 1} = {{w}^{1 *} {s}^{1 *} {c}^{1 , 1 *} {p}^{1} + {w}^{2 *} {s}^{1 *} {c}^{1 , 2 *} {p}^{1}}_{Loan 1} + {{w}^{1 *} {s}^{1 *} {c}^{2 , 1 *} {p}^{2} + {w}^{2 *} {s}^{1 *} {c}^{2 , 2 *} {p}^{2}}_{Loan 2}$$

Prior to the analysis, TD distributes shares of Beaver triples to the CRAs and the analyst. A beaver triple is just two random numbers a, b and their product c. One beaver triple is required to perform each cryptographic multiplication.

Shamir's secret sharing uses the property that an n-degree polynomial is completely defined by n+1 points. To share secrets among g-parties create a (g−1) order polynomial with the secret value as the zero-order variable.

For example, to share one Beaver Triples among the CRA and analyst, TD creates three 1^{st} order polynomials:

y₁=u₁*x+c₁

y₂=u₂*x+a₁

y₃=u₃*x+b₁

Where y is the value to be shared, us are independent random variables, a, b, and c are the Beaver triple and x is the number assigned to a party. Here, the analyst can be 1 and CRA can be 2. The shares given to the analyst are:

<y_{1,1}>=u₁*(1)+c₁

<y_{2,1}>=u₂*(1)+a₁

<y_{3,1}>=u₃*(1)+b₁

As discussed before, the <> denotes a share. The analyst knows one point on each polynomial (e.g. [1, <y_{1,1}>]) and cannot reconstruct the polynomial and hence learn the secret. Likewise, the CRA receives:

<y_{1,2}>=u₁*(2)+c₁

<y_{2,2}>=u₂*(2)+a₁

<y_{3,2}>=u₃*(2)+b₁

Note that if the parties wanted to learn the secret, they can use both points to fit a line through [1, <y1,1>] and [2, <y_{1,2}>]) with the y-intercept being the secret value. Since the equations are linear, the shares are additive. That is, the sum of the shares of two variables combine linearly. In some embodiments, other secret sharing approaches can also be applied to the analytic in lieu of Shamir's secret sharing.

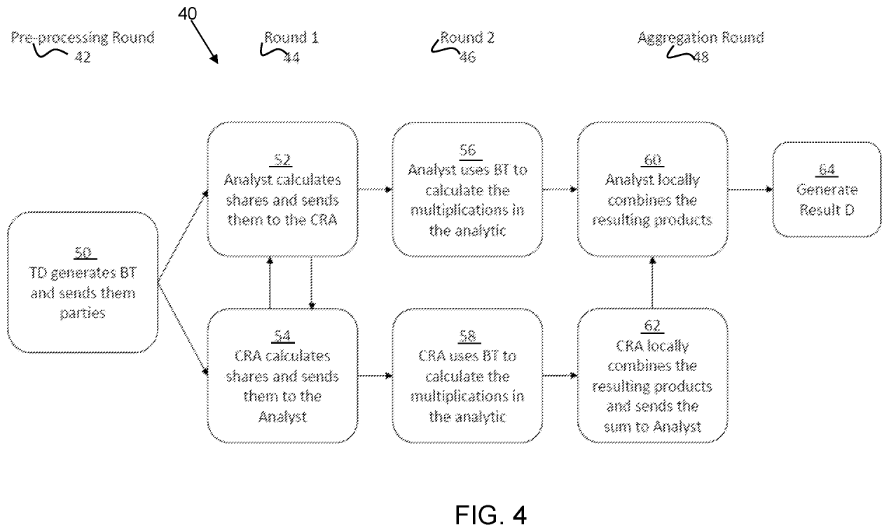

FIG. 4 shows the overall method 40 that is used in some embodiments. The method is broken into four conceptual rounds, where each party (analyst 34, TD 32, and CRA 26) performs various actions to create a cryptographic system to evaluate the financial security. During a preprocessing round 42, TD 26 performs step 50 to generate Beaver triples and send their unique shares to each party and send them to those parties (analyst 34 and CRA 26). During round one, 44, both analyst 34 and CRA 26 perform multiplication of their information and shares of the results, at steps 52 and 54. During round two, 46, analyst 34 and CRA 26 each use the Beaver triples to calculate multiplications of their analytics, at steps 56 and 58. During the fourth round of aggregation 48, analyst 34 and CRA 26 combine the resulting products from rounds one and two and pass this information to analyst 34 to generate the final result D at steps 60, 62 and 64.

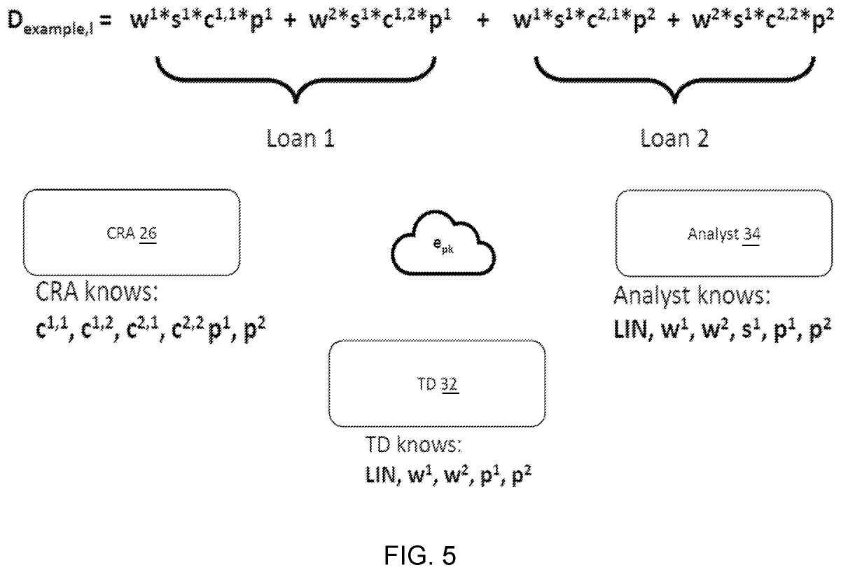

Prior to preprocessing round 42, FIG. 5 shows the information known by CRA 26, TD 32, and analyst 34. CRA 26 knows: c^{1,1},c^{1,2},c^{2,1},c^{2,2} p¹, p²; TD 32 knows: w¹, w²,p¹, p²; and analyst 34 knows: w¹, w², s¹,p¹, p². In this example, the two loan examples discussed above are used.

Preprocessing round 42: In the above simplified example, analyst 34 knows the product w^{j}*s^{j} and the CRA knows the product c^{j,i}*ⁱ—these can be done locally and do not need to be shared cryptographically. As a result, each calculation of Dₑₓₐₘₚₗₑ only requires four cryptographic multiplications:

$${D}_{e x a m p l e} = [ {{w}^{1}}^{*} {s}^{1} ] [ {c}^{1 , 1 *} {p}^{1} ] + [ {{w}^{2}}^{*} {s}^{1} ] \\ [ {{c}^{1 , 2}}^{*} {p}^{1} ] + [ {{w}^{1}}^{*} {s}^{1} ] [ {{c}^{2 , 1}}^{*} {p}^{2} ] + [ {{w}^{2}}^{*} {s}^{1} ] [ {{c}^{2 , 2}}^{*} {p}^{2} ]$$

Where each cryptographic multiplication is replaced with ⋅. There are four required cryptographic multiplications.

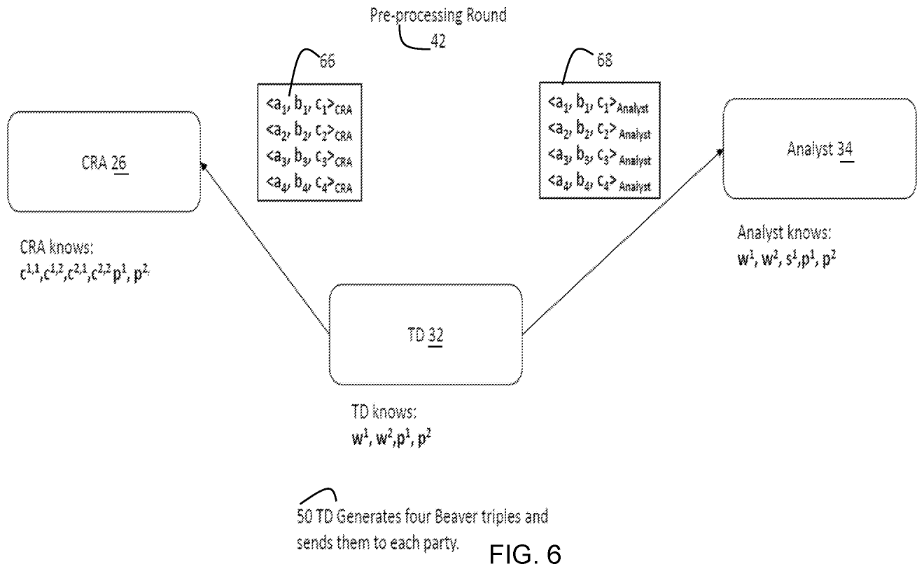

Preprocessing round 42 is shown in FIG. 6. Prior to running the analytic, TD generates four Beaver triples (66 and 68) and sends the shares of each to each party:

To CRA: <a₁, b₁, c₁>_{CRA} . . . <a₄, b₄, c₄>_{CRA} (66)

To analyst: <a₁, b₁, c₁>_{Analyst} . . . <a4, b₄, c₄>_{Analyst} (68)

Round one, 44: The analyst begins by performing the local multiplications w^{j}*s^{j}. They prepare the resulting variables for cryptographic multiplication by creating shares (as described above). To be sent to CRA: <w¹*s¹>_{CRA,1}, <w²*s¹>_{CRA,2}, <w¹*s¹>_{CRA,3}, <w², *s¹>_{CRA,4}. To be retained by the analyst: <w¹*s¹>_{Analyst,1}, <w²*s¹>_{Analyst,2}, <w¹*s¹>_{Analyst,3}, <w²*s¹>_{Analyst,4}. Note that the shares are unique for each Beaver triple—that is:

<w¹*s¹>_{CRA,1}≠<w¹*s¹>_{CRA,3}

For each cryptographic multiplication, the analyst sends the following information in one batch:

TABLE 3

| | |
|---|---|
| 1 | LIN |
| 2 | c_{label} |
| 3 | Share to be multiplied < w^{j}*s¹ > CRA,ₜ |
| 4 | The Beaver triple to be used = t |

Upon receiving the shares from the analyst the CRA performs the local multiplications c^{j,i}*pⁱ. They prepare the resulting variables for cryptographic multiplication by creating shares (as described above). To be sent to analyst: <c^{1,1}*p¹>_{Anaiyst,1}, <c^{1,2}* p¹>_{Analyst,2}, <c^{2,1}*p²>_{Analyst,3}, <c^{2,2}*p²>_{Analyst,4}. To be retained by the CRA: <c^{1,1}*p¹>_{CRA,1}, <c^{1,2}*p¹>_{CRA,2}, <c^{2,1}*p²>_{CRA,3}, <c^{2,2}*p²>_{CRA,4}. The CRA simply sends the shares to the analyst, which ends round one.

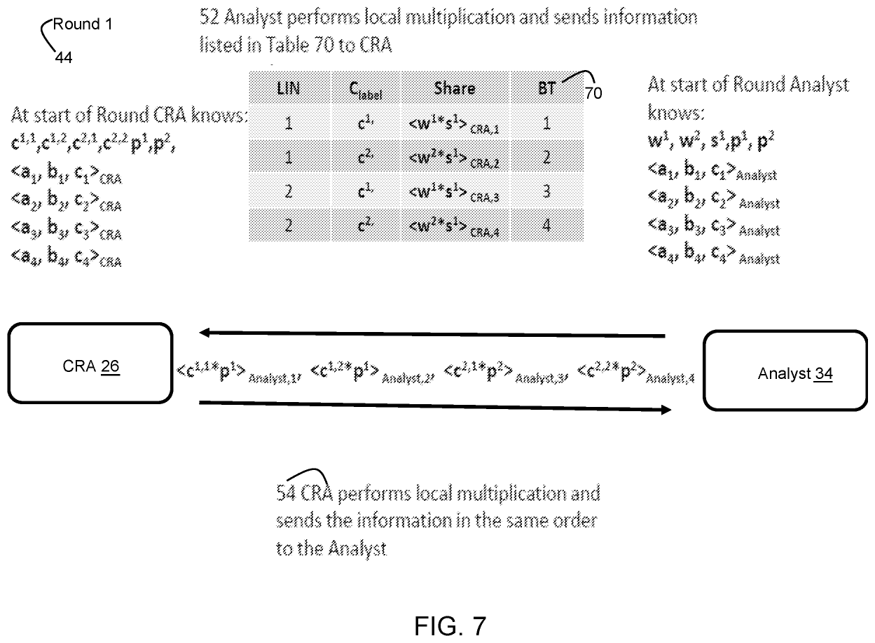

FIG. 7 illustrates the steps of round one 44. At step 52, analyst 34 performs local multiplications to create table 70, which is sent to CRA 26. At step 54 CRA also performs local multiplications and that information to analyst 34. The details of the information passed is explained above.

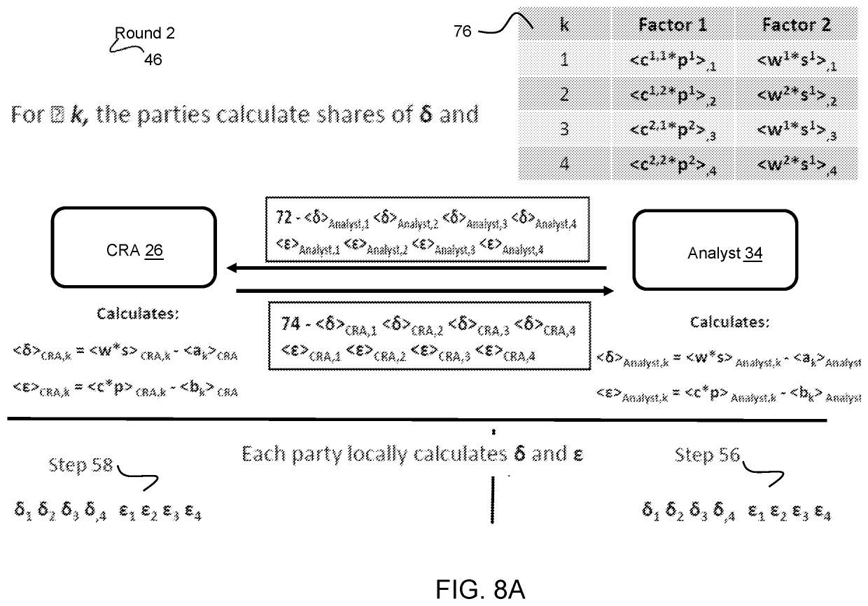

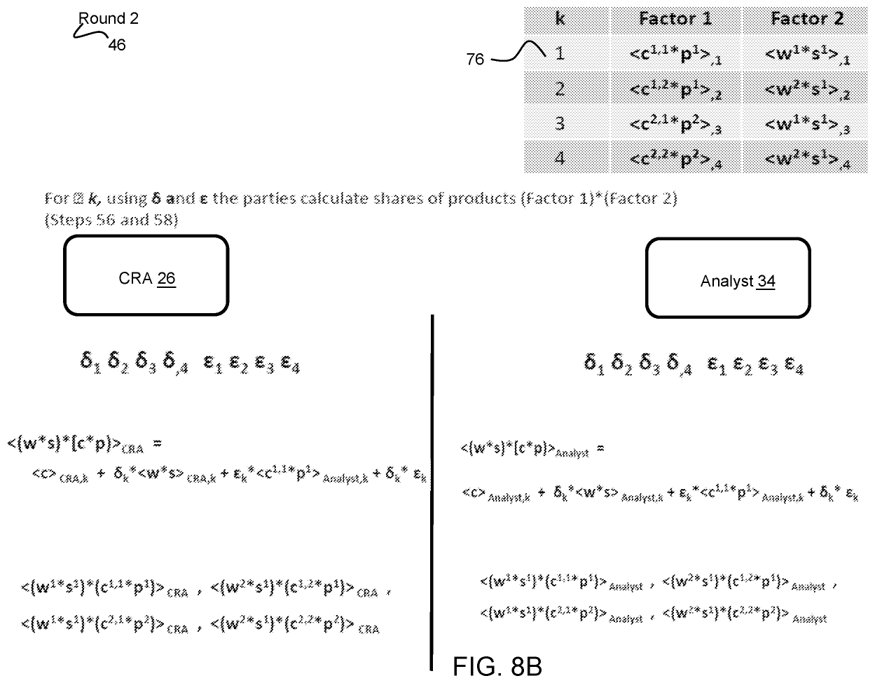

FIG. 8 illustrates the steps of round two, 46: Beaver multiplication is used because it is more efficient than the alternative which would require numerous more rounds of communications and cryptographic operations. For each cryptographic multiplication, each party subtracts the relevant beaver triple from the multiplier. For example, for the first multiplication, [w¹*s¹]⋅[c^{1,1}*p¹], analyst 34 calculates:

<δ>_{Analyst,1}=<w¹*s¹>_{Analyst,1}−<a₁>_{Analyst}

21 ε>_{Analyst,1}=<c^{1,1}*p¹_{Analyst,1}−<b₁>_{Analyst}

Similarly, the CRA calculates:

<δ>_{CRA,1}=<w¹*s¹>_{CRA,1}−<a₁>_{CRA}

<ε>_{CRA,1}=<c^{1,1}*p¹>_{CRA,1}−<b₁>_{CRA}

Similar calculations are performed for each four of the cryptographic multiplication in this example. Following this, the parties reveal each <δ> and <ε> to each other. As described in the secret sharing section, the parties which now hold both shares can calculate the individual values of δ₁ . . . δ₄ and ε₁ . . . ε₄.

It can be shown that each δ and ε is a one-time pad encryption of the relevant multiplier (e.g., [w^{j}*s^{j}], [c^{j,i}*pⁱ]). With this information, each party calculates its share of the product. The share of the product can be shown to be:

<(w¹*s¹)*[c^{1,1}*p¹)>_{Analyst}=<c>_{Analyst,1}+δ₁*<w¹*s¹>_{Analyst,1}+ε₁*<c^{1,1}*p¹>_{Analyst,1}+δ₁*ε₁

Note that in this case, δ and ε used in the above equation are not shares but whole values. The relationship above is at the core of the Beaver multiplication and is proven in the related publication.

The process of round two (46) is shown in FIGS. 8A and 8B. For each of parallel steps 56 and 58, analyst 34 and CRA 26 calculate δ and ε and then use these two calculate shares of products of factors one and two, as shown in table 76. This results in a share of the product for CRA 26 and analyst 34.

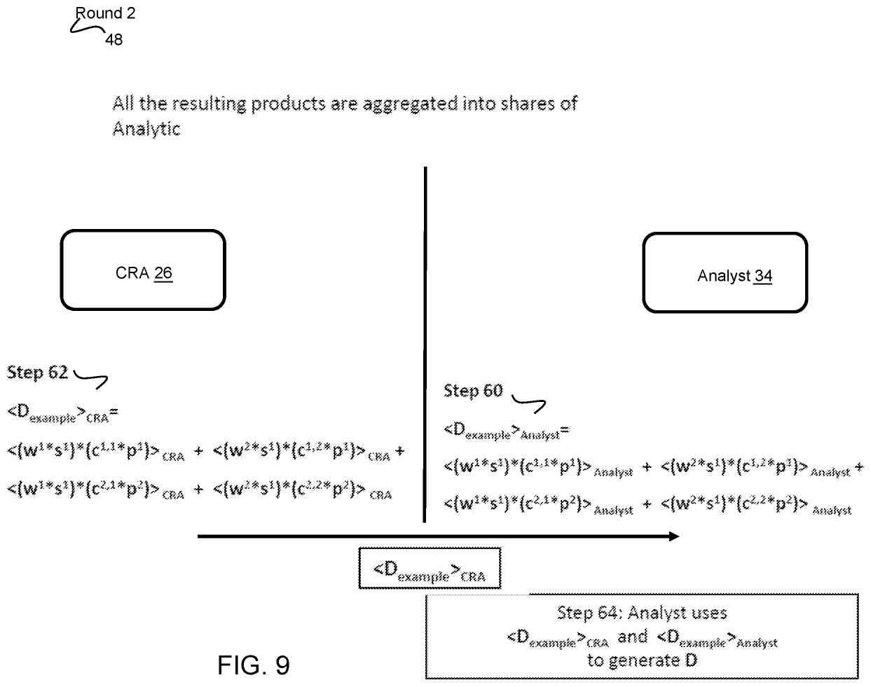

Aggregating round 48, FIG. 9: The pool level privacy requirement is satisfied by each party aggregating its shares locally. Otherwise, the analyst would be able to determine c^{j,I} and, as assumed above, trace that value to an individual consumer. Each party aggregates its shares to calculate its share of Dₑₓₐₘₚₗₑ:

<Dₑₓₐₘₚₗₑ>_{Analyst}=<(w¹*s¹)*(c^{1,1}*p¹)>_{Analyst}+<w²*s¹)*(c^{1,2}*p¹)>_{Analyst}+<(w¹*s¹)*(c^{2,1}*p²)>_{Analyst}+<(w²*s¹)*(c^{2,2}*p²)>_{Analyst}

<Dₑₓₐₘₚₗₑ>_{CRA}=<(w¹*s¹)*(c^{1,1}*p¹)>_{CRA}+<(w²*s¹)*(c^{1,2}*p¹)>_{CRA}+<(w¹*s¹)*(c^{2,1}*p²)>_{CRA}+<(w²*s¹)*(c^{2,2}*p²)>_{CRA}

As described above, since the underlying framework is linear, each share can be added locally without any loss of information. The CRA then sends <Dₑₓₐₘₚₗₑ>_{CRA} to the analyst. The analyst can now “open” Dₑₓₐₘₚₗₑ by fitting a line through [1, <Dₑₓₐₘₚₗₑ>_{Analyst}] and [2, <Dₑₓₐₘₚₗₑ>_{CRA}]. As described above, Dₑₓₐₘₚₗₑ is the y-intercept of the resulting line. This ends the aggregation round.

The process of aggregating round 48 is shown in FIG. 9. CRA 26 and analyst 34 complete parallel aggregating steps 62 and 62 generate their own share of Dₑₓₐₘₚₗₑ. Analyst 34 can then use these two shares to generate Dₑₓₐₘₚₗₑ, at step 64. This allows analyst 34 to evaluate the financial offering.

Some embodiments give financial analysts 1) control over the analytical process of analyzing consumer backed structured finance 2) without a) actual knowledge of CCI or b) running afoul of the consumer credit regulatory framework. This is accomplished via the cryptographic techniques of secure multiparty computation (MPC). MPC work where multiple parties hold disjoint sets of private information and they wish to compute a function based on that information without revealing anything except potentially the outcome. Embodiments apply MPC to the task of analyzing structured finance securities. The application of this invention will prevent a future market collapse similar to the GFC while maintaining mortgage access for consumers.

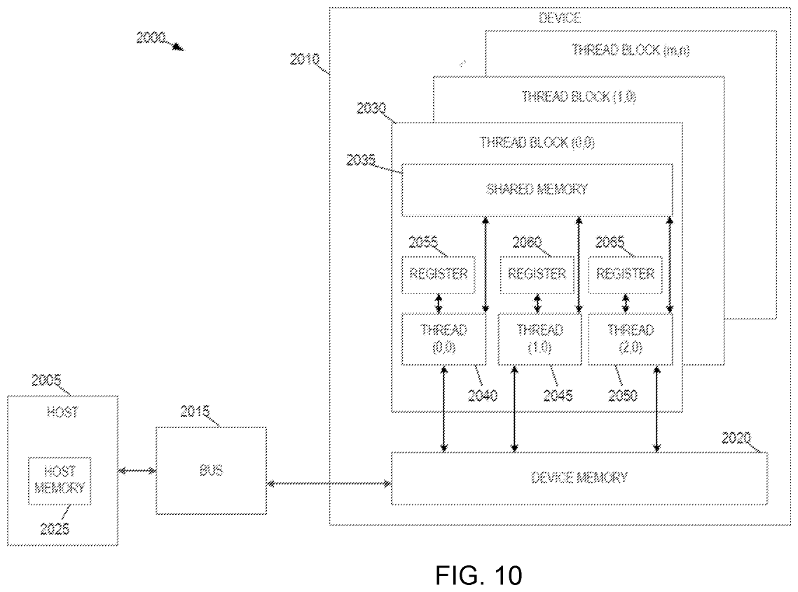

FIG. 10 provides an example of a parallel processing platform 2000 that may be utilized to implement the MPC systems described in FIGS. 2-9 or other computing systems used in accordance with the present invention. This platform 2000 may be, for example, used in embodiments of the present invention the machine learning and other processing-intensive operations which benefit from parallelization of processing tasks. This platform 2000 may be implemented, for example, with NVIDIA CUDA™ or a similar parallel computing platform). The architecture includes a host computing unit (“host”) 2005 and a graphics processing unit (GPU) device (“device”) 2010 connected via a bus 2015 (e.g., a PCIe bus). The host 2005 includes the central processing unit, or “CPU” (not shown in FIG. 10), and host memory 2025 accessible to the CPU. The device 2010 includes the graphics processing unit (GPU) and its associated memory 2020, referred to herein as device memory. The device memory 2020 may include various types of memory, each optimized for different memory usages. For example, in some embodiments, the device memory includes global memory, constant memory, and texture memory.

Parallel portions of a big data platform and/or big simulation platform may be executed on the platform 2000 as “device kernels” or simply “kernels.” A kernel comprises parameterized code configured to perform a particular function. The parallel computing platform is configured to execute these kernels in an optimal manner across the platform 2000 based on parameters, settings, and other selections provided by the user. Additionally, in some embodiments, the parallel computing platform may include additional functionality to allow for automatic processing of kernels in an optimal manner with minimal input provided by the user.

The processing required for each kernel is performed by a grid of thread blocks (described in greater detail below). Using concurrent kernel execution, streams, and synchronization with lightweight events, the platform 2000 of FIG. 10 (or similar architectures) may be used to parallelize portions of the machine learning-based operations performed in training or utilizing the smart editing processes discussed herein. For example, the parallel processing platform 2000 may be used to execute multiple instances of a machine learning model in parallel.

The device 2010 includes one or more thread blocks 2030 which represent the computation unit of the device 2010. The term thread block refers to a group of threads that can cooperate via shared memory and synchronize their execution to coordinate memory accesses. For example, in FIG. 10, threads 2040, 2045 and 2050 operate in thread block 2030 and access shared memory 2035. Depending on the parallel computing platform used, thread blocks may be organized in a grid structure. A computation or series of computations may then be mapped onto this grid. For example, in embodiments utilizing CUDA, computations may be mapped on one-, two-, or three-dimensional grids. Each grid contains multiple thread blocks, and each thread block contains multiple threads. For example, in FIG. 10, the thread blocks 2030 are organized in a two dimensional grid structure with m+1 rows and n+1 columns. Generally, threads in different thread blocks of the same grid cannot communicate or synchronize with each other. However, thread blocks in the same grid can run on the same multiprocessor within the GPU at the same time. The number of threads in each thread block may be limited by hardware or software constraints.

Continuing with reference to FIG. 10, registers 2055, 2060, and 2065 represent the fast memory available to thread block 2030. Each register is only accessible by a single thread. Thus, for example, register 2055 may only be accessed by thread 2040. Conversely, shared memory is allocated per thread block, so all threads in the block have access to the same shared memory. Thus, shared memory 2035 is designed to be accessed, in parallel, by each thread 2040, 2045, and 2050 in thread block 2030. Threads can access data in shared memory 2035 loaded from device memory 2020 by other threads within the same thread block (e.g., thread block 2030). The device memory 2020 is accessed by all blocks of the grid and may be implemented using, for example, Dynamic Random-Access Memory (DRAM).

Each thread can have one or more levels of memory access. For example, in the platform 2000 of FIG. 10, each thread may have three levels of memory access. First, each thread 2040, 2045, 2050, can read and write to its corresponding registers 2055, 2060, and 2065. Registers provide the fastest memory access to threads because there are no synchronization issues and the register is generally located close to a multiprocessor executing the thread. Second, each thread 2040, 2045, 2050 in thread block 2030, may read and write data to the shared memory 2035 corresponding to that block 2030. Generally, the time required for a thread to access shared memory exceeds that of register access due to the need to synchronize access among all the threads in the thread block. However, like the registers in the thread block, the shared memory is typically located close to the multiprocessor executing the threads. The third level of memory access allows all threads on the device 2010 to read and/or write to the device memory. Device memory requires the longest time to access because access must be synchronized across the thread blocks operating on the device.

The embodiments of the present disclosure may be implemented with any combination of hardware and software. For example, aside from parallel processing architecture presented in FIG. 10, standard computing platforms (e.g., servers, desktop computer, etc.) may be specially configured to perform the techniques discussed herein. In addition, the embodiments of the present disclosure may be included in an article of manufacture (e.g., one or more computer program products) having, for example, computer-readable, non-transitory media. The media may have embodied therein computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. No claim element herein is to be construed under the provisions of 35 U.S.C. 112(f) unless the element is expressly recited using the phrase “means for.”

What is claimed is:

1. A method of performing encrypted calculations by a third party on a pool of consumer credit data stored by a regulated consumer credit provider wherein said pool of consumer credit data comprises:
a) personal data;
b) analyte data;
wherein the encrypted calculations are performed by said third party without any disclosure of the personal data or analyte data to said third party.

2. The method of claim 1, wherein the data used by the third party to perform the encrypted calculations includes exogenous data that is data that can be used to match the pool of data with personal data.

3. The method of claim 1, wherein the analyte data comprises loan data, loan amounts, liability amounts, income, credit score.

4. The method of claim 3, wherein the personal data includes borrower's name, borrower's address, ss number.

5. The method of claim 1, wherein the personal data includes borrower's name, borrower's address, ss number.

6. The method of claim 1, wherein the pool of data comprises data on at least 10 loans.

7. The method of claim 1, wherein the pool of data comprises data on at least 100 loans.

8. The method of claim 1, wherein the pool of data comprises data on at least 1,000 loans.

9. The method of claim 1, wherein the calculations are performed with the use of secure multi-party computation using arithmetic circuits for encrypted calculations.

10. The method of claim 1, wherein the calculations are performed with the use of secure multi-party computation using a Boolean circuit for encrypted calculations.

11. The method of claim 1, wherein the calculations are performed with the use of secure multi-party computation using hybrid circuits for encrypted calculations, wherein said hybrid circuit includes the use of a Boolean circuit and an arithmetic circuit.
